(19) United States
(12) Patent Application Publication
(10) Pub. No.: US 2013/0232524 A1
(43) Pub. Date: Sep. 5, 2013

(54) SYSTEM AND METHOD FOR LEASING A TV

(71) Applicant: Brant Candelore, San Diego, CA (US)

(72) Inventor: Brant Candelore, San Diego, CA (US)

(73) Assignee: SONY CORPORATION

(21) Appl. No.: 13/409,479

(22) Filed: Mar. 1, 2012

(51) Int. Cl. H04N 21/45

(52) U.S. Cl. 725/30

(57) ABSTRACT

To disincentivize theft of a leased TV, the leased TV is tethered to a set top box (STB) by means of preventing full operation of the TV unless the TV receives periodic authorization messages from the STB. Absent a refreshing authorization message, typically sent to the TV pursuant to a periodic lease payment, the TV presents at most video with a watermark superimposed over it and no audio.

### I. FIELD OF THE INVENTION

The present application relates generally to leasing TVs.

### II. BACKGROUND OF THE INVENTION

Present principles recognize that leasing TVs to consumers can be a win-win all around. The consumer is able to enjoy the latest TV technology without having to pay the full sale price up front. At the end of the lease period, the customer can buy the TV if desired or turn it back in for a newer model. The TV manufacturer pumps sales, and the TV service provider gains an additional customer.

As also understood herein, however, steps should be taken to prevent easy theft of the TV. A lessee could, for example, simply move, take the leased TV with him, and cancel his credit card on file, thereby defeating the business case of the lease. Accordingly, present principles are provided.

### SUMMARY OF THE INVENTION

In general, various embodiments below seek to disable normal TV functionality if the leased TV is not authorized. The viewer must keep making lease payments in order for the TV to keep receiving authorization updates needed to keep it functioning or de-authorization messages to explicitly take away functionality. The TV lease may or may not be managed by a service operator providing pay-TV or other service. In the case of the service operator, the TV might work normally only when electronically tethered to a TV outlet from the particular service provider. In the case of being managed by a 3^{rd} party, e.g. the TV manufacturer, TV retailer, or other entity, TV authorization messages might be passed through the TV outlet or received independently through other means, e.g. a separate phone or Internet connection, from an authorization web portal being operated for the 3^{rd} party.

Accordingly, a method includes leasing a TV to a lessee and electronically tethering the TV to a TV signal outlet such that the TV presents unobstructed TV programming for a period of time without communicating with the TV signal outlet.

The TV signal outlet can be a terrestrial broadcast, cable, IPTV, or satellite set top box or an Internet network interface such as cable, satellite, or ISDN modem. The electronically tethering may include cryptographic binding. For example, at the TV, receiving an authorization message from the TV signal outlet, and causing the TV to decrypt the authorization message to render a code. The method may further include causing the TV to compare the code with a check code, and responsive to a determination that the code does not match the check code, causing the TV to reject the authorization message. If the check code matches, then the TV processes the message. The message may include a sequence number which increments with each new authorization message. And the message is checked to see if the sequence has advanced. Alternatively, the message may contain a validity time period, and the validity time period is checked against current time to see if it should be acted upon. Assuming that all the checks are OK, then the message can be processed. It is to be understood that not all TV features need be enabled in a message and if the message is a de-authorizing one, features could be taken away. Some features, 3D or built-in personal video recorder (PVR) functionality, may require an additional payment from the customer. However, responsive to a determination that the code matches the check code and the message is for the current time period and not a repeated or old message, then message can be acted upon and features of the TV can be enabled or disabled as called out in the authorization message. Enabling TV features can mean providing unobstructed TV usage, e.g. rendering of programming and video/audio input use, according to user commands. Likewise, if a customer cancels the service, an authorization message can take away functionality from the TV ahead of a normal expiration. And even if a customer were able to block this de-authorization message, feature disablement would occur as a normal course of expiration of the authorization period.

For network enabled TVs, feature enablement can include the navigation to Internet websites and the playback of web content. The authorization message may indicate a renewal period, and could enable all or selected features on the TV only for the renewal period absent receipt of a refreshing authorization code from the TV signal outlet.

The authorization message from the TV signal outlet can be received on a high definition multimedia interface (HDMI) link or other interface such as Ethernet, Homeplug, USB, or MOCA. The TV signal outlet can receive the authorization message from a distributor of TV programming which in turn can receive the authorization message from a different party such as a lessor of the TV or manufacturer of the TV.

The authorization may be received at periodic intervals by the TV responsive to lease payments being timely made, or the authorization may be received upon occurrence of a predetermined use event of the TV. For example, the use event can be TV power on and/or manipulation of a predetermined key or keys on a remote control, e.g. channel change or input change. The TV can interact with the TV outlet or authorization portal out on the Internet in order to check for authorization real-time. The advantage of such a method is that the TV does not need to maintain a sense of time. The TV checks for authorization based on certain events that will necessarily occur over time when using the TV. Upon failure to determine authorization, a user interface is used to instruct a user to contact a leasing source to activate or renew the TV's capability. And if the TV is not connected to the TV outlet, then troubleshooting information is displayed instructing the user to make the connection.

It is also possible for the TV outlet itself to generate the authorization message for the TV. In that scenario, the TV outlet gets separate enablement in order to work with a particular or certain model of lease TVs from a particular manufacturer.

In some examples, to receive the authorization message from the TV signal outlet, the TV sends to the TV signal outlet a filter identification usable by the TV signal outlet to filter out authorization messages that may be broadcast to the TV outlet from being sent on to the TV that do not conform to the filter identification since these would not pertain to the TV.

In some examples, an initial authorization message received from the TV signal outlet by the TV establishes a time in the TV used by the TV in its powered up state to measure the renewal period. The authorization messages are ideally encrypted uniquely for a particular TV. If desired, the TV is a leased TV having a leased TV model number, and no non-leased TV has the model number. This may help prevent a customer from modifying the software of the leased TV to be that of a non-leased TV.

As set forth further below, each time the TV is energized during the renewal period, the TV may compare a code received in the authorization message with a calculated check code or well-known check code, and subsequently process the authorization message only responsive to a determination that the code matches the check code. The above-mentioned authorization message can have a sequence number unique to the authorization message so that can be used to prevent the replay of the message by someone wishing to circumvent the proper authorization of the TV.

As contemplated in non-limiting examples, the electronically tethering can also include, at the TV, receiving an authorization message from the Internet, causing the TV to process the authorization message to render a code, causing the TV to compare the code with a check code in a memory of the TV, and responsive to a determination that the code does not match the check code, which would be evidence of some type of tampering of the message, causing the TV to stop presenting unobstructed TV usage. The message may have a check code which does match, but also takes away certain selected features from the TV. For example, the message could remove all the functionality of the TV except the capability to communicate with the viewer through an on-screen display. Alternatively, the authorization could enable all functionality of the TV, causing the TV to present unobstructed TV usage according to user commands.

A time in the TV used by the TV to measure the renewal period can be received from a secure Internet source of time. Alternatively, the TV may acquire a coarse sense of time from authorization messages. For example, a message can be sent at the beginning of a month. The TV can determine how long it has been powered-up since the receipt of the new message.

A user of the TV may be permitted to purchase the TV during or at an end of a lease period by presenting an unlock user interface on the TV prompting the user to enter an unlock code which, responsive to a determination that the unlock code matches a prestored unlock code, untethers the TV from the TV signal outlet so that the TV can be used with full TV functionality without needing to receive future messages from the TV signal outlet.

In another aspect, a method to disincentivize theft of a leased TV includes receiving, at a location remote from a leased TV, information pertaining to the leased TV, and providing, through a network interface communicating with the leased TV, authorization messages to the leased TV. Full operation of the leased TV is prevented unless the TV timely receives an authorization message.

In another aspect, a TV has a TV display, a TV processor controlling the display, and a computer readable memory accessible to the processor and bearing instructions executable by the processor to configure the TV in a reduced functionality mode, in which no audio is presented regardless of what TV channel the TV is tuned to and at most video overlaid with a visually obstructing watermark is presented. A user of the TV is unable to remove the watermark in the reduced functionality mode. The processor, responsive to receiving an authorization message which enables TV features, configures the TV in some or full functionality mode, in which the TV presents audio and video unobstructed by the watermark.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of an example TV leasing system in which the leased TV is “tethered” to a signal provider set top box (STB) by means of periodic lease authorization messages, referred to herein as “TV_Auth” messages;

FIG. 2 is a block diagram of an example STB with an example TV;

FIG. 3 is a flow chart of example logic for initiating the lease;

FIG. 4 is an example screen shot of a set up user interface (UI) that is presented when the leased is first energized by the lessee;

FIG. 5 is a flow chart of example logic for initializing the TV;

FIGS. 6 and 7 are screen shots of example onscreen displays (OSD) prior to completing TV authorization, respectively when an authorized STB is not detected and when one is detected;

FIG. 8 is a flow chart of example TV operating logic; and

FIG. 9 is a screen shot of an example UI for permanently unlocking a leased TV incident to full sale of the TV.

### DETAILED DESCRIPTION OF THE PREFERRED EMBODIMENT

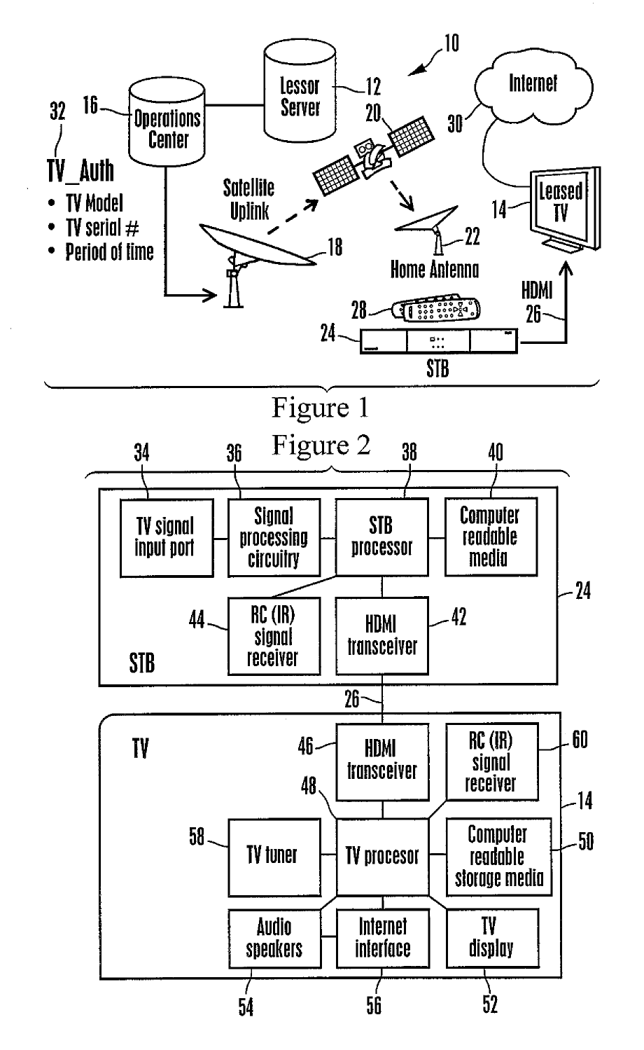

Referring initially to FIG. 1, a system is shown, generally designated 10, which includes a lessor computer server 12 controlled by or otherwise associated with a lessor of a leased TV 14 and communicating with an operations center server 16, typically controlled by or otherwise associated with a TV signal provider. In the example shown, the TV signal provider is a satellite TV signal provider that uplinks TV signals through a base antenna 18 to a satellite 20, which relays the signals to multiple home satellite antennas 22. Each home antenna 22 is connected to one or more home integrated receiver/decoders (IRD) 24, also referred to herein for familiarity as a “set top box” (STB). As shown in FIG. 1, signals from the STB 24 are sent, typically via a wired or wireless high definition multimedia interface (HDMD link 26, to the TV 14 for display thereof. The TV 14 and STB 24 may be controlled by one or more remote commanders (RC) 28. The TV 14 may also communicate with the Internet 30.

Various aspects should be understood about the embodiment shown in FIG. 1. While the example shown assumes a satellite TV signal provider, the signal provider may be a cable TV provider, in which case the STB 24 is a cable TV STB. Or, the signal provider may be an Internet Protocol TV (IPTV) signal provider in which case the STB equivalently is embodied by a network interface such as a modern or WiFi transceiver. It should also be understood that while FIG. 1 shows that a TV authorization message 32 (“TV_Auth”) can be embedded in the TV signal stream and sent from the operations center server 16 over the satellite link to the TV 14, and that the TV_Auth message 32 includes a TV model and TV serial number as well as a period of time described further below, in other instantiations the TV_Auth message may be received from the Internet 30 directly by the TV 14 and it may not include a period of time. Each of the servers shown typically includes one or more digital processors accessing one or more computer readable storage media such as solid state memory, disk memory, and the like to execute relevant portions of the logic described below.

Now referring to FIG. 2, in the example shown the STB 24 receives TV signals at a TV signal input port 34, and the signals are conveyed to signal processing circuitry which, among other things, digitizes the signals to render them usable to a digital STB processor 38. The STB processor 38 can access computer readable storage media 40 such as disk or solid state storage to execute relevant logic set forth herein.

As also shown in FIG. 2, the processor 38 may output TV signals to a HDMI transmitter 42 for supply of the signals onto the HDMI link 26. User commands from, e.g., one of the RCs shown in FIG. 1 may be received by the STB processor 38 through a command receiver 44 such as an infrared (IR) receiver.

FIG. 2 shows that TV signals on the HDMI link 26 are received at the TV 14 by a HDMI receiver or transceiver 46 for provisioning to a TV digital processor 48 accessing computer readable storage media 50 such as disk or solid state storage to execute relevant logic set forth herein. The TV signals are output to a TV display 52 and audio speakers 54 controlled by the TV processor 48, which can access the Internet as intimated above through a network interface 56 such as a wired or wireless modem. Note that while FIG. 2 shows that the TV signals are provided to the processor 48 from the HDMI receiver 46, in actual implementation the signals may be routed to a TV tuner 58 controlled by the processor 48 and thence through display drivers to the TV display 52. User commands from a RC can be received by the TV processor 48 through a command signal receiver 60.

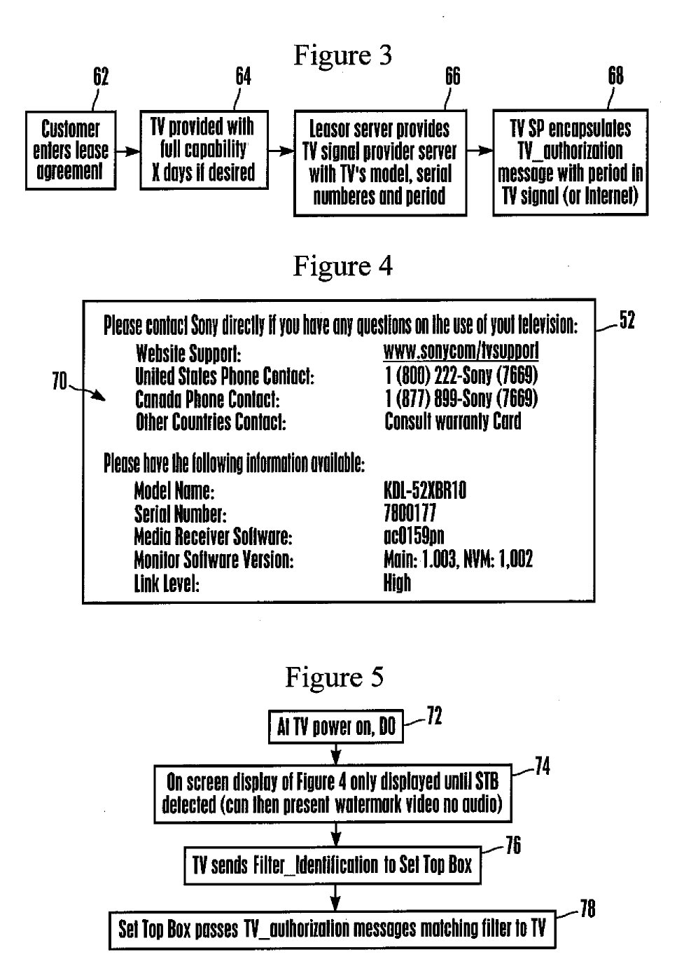

Now referring to FIG. 3, example logic is shown for commencing a lease of the TV 14. At block 62 the customer enters a lease agreement with a lessor of the TV 14. The lessor may be the manufacturer of the TV, or the lessor may be an agent or business partner of the TV manufacturer. The TV 14 is provided to the customer at block 64, either requiring the below-described authorization upon connection in the home for full functionality or, if desired, delivered with full functionality enabled for a limited period, e.g., for 30 days—the billing cycle.

Moving to block 66, the lessor server 12 shown in FIG. 1 provides the operations center server 16 the model number and serial number of the TV 14 and if desired a number of days for which the authorization permits the TV to be used with full functionality, e.g., thirty days, upon the expiry of which the TV reverts to partial functionality as explained further below absent a refreshing authorization. The TV service provider encapsulates the above information at block 68, encrypting it as necessary, in a TV_Authorization message which may be embedded in the TV signal stream, although as mentioned above the TV_Authorization message may be alternately delivered over the Internet. Note that present principles may use different model numbers for leased TVs as compared to the model numbers for sold TVs. Thus, two identical TVs may have different model numbers to indicate that one of the TVs is intended for sale and the other TV intended for lease, such that no TV intended to be sold by the manufacturer will have a model number of any TV intended to be leased by the manufacturer. Occasionally a manufacturer will make updates available to users. By making the model different, it will make it difficult for a user to load a non-lease program intended for a different TV into a leased TV thereby defeating its security.

FIG. 4 shows a screen shot 70 that can be presented on the TV display 52 when the TV 14 is power up initially in the lessee's home at block 72 of FIG. 5. As shown in FIG. 4, the non-limiting example screen shot 70 instructs the viewer as to contact information for setting up the TV for leased usage and also provides the viewer with information identifying the TV 14 such as serial number, model number, and TV software information.

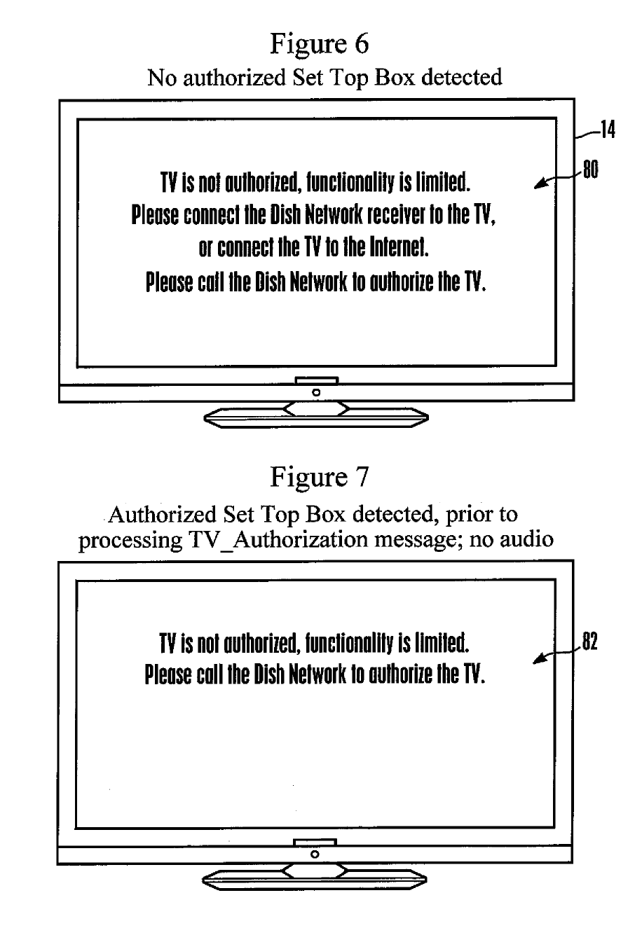

As indicated at block 74 of FIG. 5, the screen shot of FIG. 4 may be presented until such time as the TV 14 detects the STB 24 shown in FIG. 1, it again being understood that Internet communication alternatively may be used. Should no STB be detected, the screen shot 80 of FIG. 6 may be presented, informing the viewer to connect the TV 14 to the STB 24 or Internet and if desired to contact a TV signal provider with the information shown on the screen shot of FIG. 4.

In any case, once the STB 24 is detected by the TV 14 using, e.g., HDMI discovery principles, in some example embodiments the screen shot 82 of FIG. 7 may be presented. It is to be appreciated that the TV 14 is not yet in full functionality mode since in the screen shot of FIG. 7, no audio is presented and only video is presented, with the video being partially obscured by the depicted watermark. In the embodiment shown, the watermark is an alpha numeric message to contact the appropriate party to establish a lease and, thus, full functionality of the TV 14.

Once the TV 14 detects the STB 14, at block 76 in FIG. 5 the TV sends its identification to the STB 24. This identification is a filter identification which the STB 14 uses to filter out all TV_Authorization messages except those pertaining to the particular TV 14. The filter may be the serial number of the TV. In this way, the STB 24 passes only TV_Authorization messages intended for the TV 14 to the TV 14 at block 78, since it simply compares the filter identification received from the TV 14 with the TV identifications in the various TV_Authorization messages received in TV signals from the operations center server 16 and passes to the TV 14 only those TV_Authorization messages matching the filter identification.

The way in which the TV configures itself for full functionality upon receipt of a TV_Authorization message may now be better understood. The TV_Authorization message may be encrypted or otherwise encoded, and the TV processor 48 decodes the authorization message to render a code. The TV processor 48 compares the code with a check code, and responsive to a determination that the code does not match the check code, the TV rejects the message. Alternatively, as an anti-tampering measure, the TV can stop (or does not start) presenting unobstructed TV programming. It may, however, present the screen shot 82 of FIG. 7 without audio in seine embodiments.

On the other hand, responsive to a determination that the code matches the check code, the TV processor processes the message. The message is examined in more detail. For example, the sequence number or time field, if used as discussed later, are checked against the current sequence number and current time. If everything checks out, then the features to be enabled are processed. The TV can present some or all unobstructed TV programming per the authorization message and according to user commands. This can include full audio and unobstructed video presentation and full functionality of other TV 14 features.

In some cases, the authorization message indicates a renewal period, and TV processor 48 is programmed to present unobstructed TV programming according to user commands only for the renewal period absent receipt of a refreshing authorization code from the TV signal outlet. In these embodiments, a new TV_Authorization message typically is sent only responsive to receipt by the lessor of the TV 14 of a periodic lease payment from the lessee. In other embodiments, the TV 14 may, upon occurrence of a predetermined use event of the TV, request or have pushed to it automatically by the STB a new authorization code. This predetermined use event may be, by way of non-limiting examples, TV power on, TV channel change command, e.g., from the RC 28, and TV input change command, e.g., from the RC 28. Thus, every time the TV is turned on, for instance, the TV must request and receive a valid TV_Authorization message from the STB to configure the TV in the full functionality mode. Note that an initial authorization message received from the STB by the TV may establish a time in the TV used by the TV to measure the renewal period. Or, time in the TV used by the TV to measure the renewal period may be received from a secure Internet source of time.

In example embodiments, the code in the authorization message can be encrypted and the TV has no public key stored in it related to a private key used to decrypt the code. This is for augmented security purposes. If desired, the TV processor 48 can access stored codes in its local memory 50 each time the TV is energized during the renewal period to compare the computed stored code previously received in the authorization message with the check code and subsequently respond to user commands to execute full TV functionality only responsive to a determination that the code matches the check code. This is to further augment security, since less secure embodiments may do no more than set a full functionality flag for the duration of the renewal period indicating full functionality and that flag may be too easily altered by a thief. To foil unauthorized replaying of an old authorization message and fooling the TV processor 48 into thinking that it is receiving a new authorization, each authorization message for a particular TV has a sequence number unique to the authorization message and TV, and the TV processor 48 simply tracks which number was last received, ignoring a new authorization message from the STB having a sequence number equal to or less than the sequence number of the most recent authorization message received by the TV.

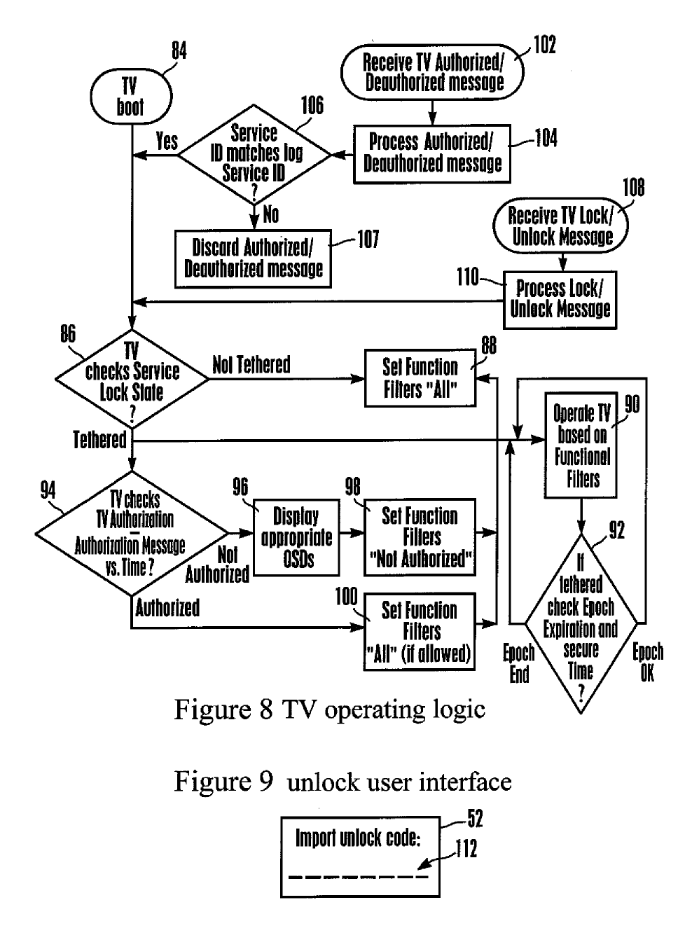

FIG. 8 shows additional non-limiting example implementation details that may be established. At state 84 the TV boots at power on. The logic then determines, at decision diamond 86, whether it is a tethered TV, i.e., a TV subject to the lease logic above requiring valid TV_Authorization messages for full functionality. If the TV is not tethered the logic moves to block 88 to set function filters to “all”, i.e., to configure itself in the full functionality mode in which it operates at block 90. Decision diamond 92, while not needed for the logic branch just described, is needed for a logic branch to be described shortly, and at this step in the logic the TV if tethered checks to ensure that the authorization time period in the most recently received TV_Authorization message has not expired. If the period has not expired the logic loops back to block 90.

In contrast, if the period has expired at decision diamond 92, the logic moves to decision diamond 94 to determine if it has received a renewed TV_Authorization message, either upon request or automatically pushed from the STB (or in those embodiments incorporating it, from an Internet source). If not, the logic moves to block 96 to present the appropriate onscreen displays, e.g., the screen shots 80 or 82 of FIG. 6 or 7. The logic then moves to block 98 to set at least some function filters as not authorized, e.g., to cease display of audio and to overlay a watermark on video as described above. The logic then moves to block 90 to operate in accordance with the filter settings at block 98.

However, if a new TV_Authorization message is received at decision diamond 94, the logic moves to block 100 to set function filters to “all”, i.e., to configure itself in the full functionality mode in which it operates at block 90.

State 102 indicates an example ancillary feature that may be used to enable a remote authority, through, e.g., the operations center server 16, to permanently authorize or deauthorize a TV for full functionality usage to support an end-of-lease purchase by the user, permanently eliminating the requirement to receive TV_Authorization messages in order to configure the TV in the full functionality mode (in the case of authorization) or to permanently prevent the TV from ever being used in the full functionality mode (in the case of deauthorization sent, e.g., responsive to a determination that the lessee has stolen the TV). The authorization/deauthorization message is received at block 104, and the TV determines, at decision diamond 106, whether a special service identification in the message matches a check service ID which preferably is different from the check code described above. If no match is found the message simply is discarded at block 107. If a match is found, in the case of an authorization message the service lock state is set to “unlock” such that a subsequent determination at decision diamond 86 always will result in a “not tethered” outcome to permanently set full functionality of the TV. In the case of a deauthorization message the determination at decision diamond 86 always will result in a “tethered” outcome which, coupled with a lack of any renewing authorization messages at decision diamond 94, will permanently render the TV in a reduced functionality mode.

Similarly, state 108 indicates an example ancillary feature that may be used to temporarily lock and unlock a TV from being tethered to support remote servicing and troubleshooting. The message is processed at block 110 and in the case of an unblock message, the service lock state is set to “unlock” such that a subsequent determination at decision diamond 86 will result in a “not tethered” outcome once only. In the case of a block message, the service lock state is set to “lock” such that a subsequent determination at decision diamond 86 will result in a “tethered” outcome once only. After the single use afforded by the temporary procedure initiated at state 108, normal functioning at state 84 resumes for the next power on.

FIG. 9 illustrates an example user interface that can be presented on the TV to facilitate the permanent authorization at states 102 and 104 described above pursuant to a purchase of the TV. A user of the TV may be permitted to purchase the TV during or at an end of a lease period by presenting an unlock user interface 112 on the TV, prompting the user to enter an unlock code. This code may be received at a remote site which sends the service ID to the TV as described above. Responsive to a positive determination at decision diamond 106, recall, the TV is untethered from the TV signal outlet so that the TV can be used with full TV functionality without receiving messages from the TV signal outlet.

While the particular SYSTEM AND METHOD FOR LEASING A TV is herein shown and described in detail, it is to be understood that the subject matter which is encompassed by the present invention is limited only by the claims.

What is claimed is:

1. Method comprising:
electronically tethering a leased TV to a TV signal outlet; and
preventing some or all use of the TV if an authorization message has not been received within a period of time from the TV signal outlet.

2. The method of claim 1, wherein the TV signal outlet is a terrestrial broadcast, cable, IPTV, or satellite set-top box.

3. The method of claim 1, wherein the TV signal outlet is an Internet network interface.

4. The method of claim 1, wherein the act of electronically tethering includes:
at the TV, receiving an authorization message from the TV signal outlet;
causing the TV to validate the authorization;
responsive to a determination that the authorization message is valid, to process the message, and if the authorization message is not validated to ignore the message or implement an anti-tampering countermeasure.

5. The method of claim 4, wherein the message is validated, processing the message to determine the renewal period, and renewal period is the current period, to enable or disable features in the TV.

6. The method of claim 4, wherein the TV receives the authorization message from the TV signal outlet on a high definition multimedia interface (HDMI) link.

7. The method of claim 4, wherein the TV signal outlet receives the authorization message from one of the following: source of TV programming, lessor of the TV, and manufacturer of the TV.

8. The method of claim 4, wherein an authorization message is received at periodic intervals by the TV responsive to lease payments being timely made, or the authorization message is received upon occurrence of a predetermined use event of the TV.

9. The method of claim 1, wherein prior to tethering the TV to the TV signal outlet, the TV presents, at power on, a user interface instructing a user to contact a leasing source to activate full TV capability.

10. The method of claim 8, wherein the use event is TV power on and/or manipulation of a predetermined key or keys on a remote control.

11. The method of claim 4, wherein to receive the authorization message from the TV signal outlet, the TV sends to the TV signal outlet a filter identification usable by the TV signal outlet to filter out authorization messages from being sent to the TV that do not conform to the filter identification.

12. The method of claim 5, wherein an initial authorization message received from the TV signal outlet by the TV establishes a time in the TV used by the TV to measure the renewal period.

13. The method of claim 1, wherein the TV is a leased TV having a leased TV model number, and no non-leased TV has the same model number.

14. The method of claim 4, wherein the code in the authorization message is encrypted and the TV has no public key stored in it related to a private key used to decrypt the code.

15. The method of claim 5, wherein each time the TV is energized during the renewal period, the TV compares the code received in the authorization message with the check code and subsequently responds features being authorized only on a determination that the code matches the check code.

16. The method of claim 4, wherein the authorization message has a sequence number unique to the authorization message.

17. The method of claim 1, wherein the act of electronically tethering includes:
at the TV, receiving an authorization message from the Internet;
causing the TV to decode the authorization message to render a code;
causing the TV to compare the code with a check code in a memory of the TV;
responsive to a determination that the code does not match the check code, causing the TV ignore the message or to stop presenting unobstructed TV programming; and
responsive to a determination that the code matches the check code, causing the TV to present unobstructed TV programming according to user commands.

18. The method of claim 5, wherein a time in the TV used by the TV to measure the renewal period is received from a secure Internet source of time.

19. The method of claim 1, comprising enabling a user of the TV to purchase the TV during or at an end of a lease period by presenting an unlock user interface on the TV prompting the user to enter an unlock code which, responsive to a determination that the unlock code matches a prestored unlock code, untethers the TV from the TV signal outlet so that the TV can be used with full TV functionality without receiving messages from the TV signal outlet.

20. A method to disincentivize theft of a leased TV, comprising:
receiving, at a location remote from a leased TV, information pertaining to the leased TV; and
providing, through a network interface communicating with the leased TV, authorization messages to the leased TV, full operation of the leased TV being prevented unless the TV timely receives an authorization message.

21. The method of claim 20, wherein the network interface is an Internet interface and/or a set top box.

22. The method of claim 20, comprising:
at the TV, receiving an authorization message from the network interface;
causing the TV to decode the authorization message to render a code;
causing the TV to compare the code with a check code in a memory of the TV;
responsive to a determination that the code does not match the check code, causing the TV to ignore the message or stop presenting unobstructed TV programming and permitting the TV to present at most video with a watermark superimposed over it and preventing the TV from playing audio; and
responsive to a determination that the code matches the check code, causing the TV to present features authorized in the authorization message according to user commands.

23. The method of claim 22, wherein the authorization message indicates a renewal period, and the method further includes, responsive to a determination that the code matches the check code, causing the TV to present unobstructed TV programming according to user commands only for the renewal period absent receipt of a refreshing authorization code from the TV signal outlet.

24. The method of claim 20, wherein prior to tethering the TV to the network interface, the TV presents video obstructed by a watermark superimposed on the video.

25. The method of claim 22, wherein to receive the authorization message, the TV sends a filter identification usable to filter out authorization messages from being sent to the TV that do not conform to the filter identification.

26. TV comprising:
TV display;
TV processor controlling the display; and
computer readable memory accessible to the processor and bearing instructions executable by the processor to configure the TV in a reduced functionality mode, wherein no audio is presented regardless of what TV channel the TV is tuned to and at most video overlaid with a visually obstructing watermark is presented, a user of the TV being unable to remove the watermark in the reduced functionality mode, the processor, responsive to receiving an authorization message, configuring the TV in a full functionality mode, in which the TV presents audio and video unobstructed by the watermark.

27. The TV of claim 26, wherein the TV receives the authorization message from the Internet and/or a cable and/or terrestrial broadcast and/or satellite TV provider set top box (STB).

28. The TV of claim 26, wherein the authorization message indicates a period during which the TV processor configures the TV in the full functionality mode, the TV configuring the TV in the reduced functionality mode at the end of the period unless another authorization message is received.

29. The TV of claim 26, wherein the instructions when executed by the processor cause the processor to:
decode the authorization message to render a code;
compare the code with a check code accessible to the processor;
responsive to a determination that the code does not match the check code, configure the TV in the reduced functionality mode; and
responsive to a determination that the code matches the check code, configure the TV in the full functionality mode.

30. The TV of claim 29, wherein the authorization message indicates a renewal period, and the processor, responsive to a determination that the code matches the check code, configures the TV in the full functionality mode only for the renewal period absent receipt of a refreshing authorization code from the TV signal outlet.

31. The TV of claim 26, wherein to receive the authorization message, the TV processor sends a filter identification usable to filter out authorization messages from being sent to the TV that do not conform to the filter identification.

32. The TV of claim 26, wherein an initial authorization message received by the TV processor establishes a time in the TV used by the TV processor to measure the renewal period.

33. The TV of claim 26, wherein the TV is a leased TV having a leased TV model number, and no non-leased TV has the model number.

34. The TV of claim 26, wherein each time the TV is energized during the renewal period, the TV processor compares the code received in the authorization message with the check code and subsequently responds to user commands to execute full TV functionality only responsive to a determination that the code matches the check code.

35. The TV of claim 26, wherein the processor receives the authorization message from the Internet.

36. The TV of claim 26, wherein a time in the TV used by the TV processor to measure an authorization period is received from a secure Internet source of time.

37. The TV of claim 26, wherein the processor presents on the display an unlock user interface prompting a viewer to enter an unlock code which, responsive to the processor determining that the unlock code matches a prestored unlock code, causes the processor to permanently configure the TV in the full functionality mode without requiring receipt of any further authorization messages.

38. The TV of claim 26, wherein the authorization message is received at periodic intervals by the TV responsive to lease payments being timely made, or the authorization message is received upon occurrence of a predetermined use event of the TV, the use event being manipulation of a predetermined key or keys on a remote control.
